(19) United States
(12) Patent Application Publication
(10) Pub. No.: US 2014/0279040 A1
(43) Pub. Date: Sep. 18, 2014

(54) SYSTEM AND METHOD FOR CREATING AND TARGETING MARKETING MATERIALS TO GROUPS ON THE BASIS OF GROUP COMPOSITION

(71) Applicant: Clint Kuboyama, Fort Lauderdale, FL (US)

(72) Inventor: Clint Kuboyama, Fort Lauderdale, FL (US)

(21) Appl. No.: 13/833,704

(22) Filed: Mar. 15, 2013

(51) Int. Cl. G06Q 30/02

(52) U.S. Cl. CPC G06Q 30/0269
USPC 705/14.66; 705/14.64

(57) ABSTRACT

A method of marketing by delivering advertisements and promotional offers to groups comprises preparing promotional offers to be redeemed by groups meeting predetermined conditions related to number of group members, group members' ages and gender, location and anticipated time for promotional offer to be redeemed, and delivering such offers to groups meeting such conditions. Delivery of promotional offers is done via any combination of the internet, a proprietary group server, an advertising exchange, merchants' and publisher's web sites, and cellular communications networks. Redemption of offers is reported to participating entities so that an accounting for revenues may be completed.

### BACKGROUND OF THE INVENTION

Service oriented businesses such as restaurants, bars, clubs and those that provide activity-based services (such as tours, boat rides, hikes, and other tourist-type activities) are often patronized by groups of related individuals. These groups may be comprised of two or more friends who decide to go out on a particular day or evening, or a group may consist of family members on vacation, for example. Thus, the group that is often formed to consume the services of these types of business may exist as a cohesive group for a single day or night, for a group of friends, or for a number of days, as would be the case with a family or group of friends on a week's vacation. This group of related individuals will travel collectively as a cohesive group to the service business, and may be expected to consume the services as a group unit.

Group units that visit a service oriented business come in many different compositions. The combinations of group size, and sexual and age mix of its members, can vary greatly. Different group compositions provide advertisers with untapped opportunities to structure promotional offers that can optimize client mix and business profitability. For example, a restaurant may find that the profitability on mixed drinks is higher than on food and that men tend to drink more than women. Thus, the restaurant could create a promotional offer for groups comprised of both women and men by offering the women in the group a free food item with the expectation that the drinks purchased by the men in the group would more than offset the loss on the food. In order for this to be effective, the number of men in the group would have to be a particular number or greater and the number of women a particular number or fewer. Thus, the mix of men and women in the group, and group size, would be of importance in designing a promotional offer targeted at groups. Furthermore, if the restaurant typically attracts younger patrons, it would be beneficial for the restaurant to target groups with a target average age range. If the promotional offer is targeted at and offered to groups with the desired group composition, the probability of its being effective increases as the group composition the promotional offer was structured for is specifically targeted. In such a case, the restaurant may take advantage of group compositions to structure and target promotional offers in a way that currently does not exist.

In another example, a bar owner may determine that men tend to drink more than women, and that as the number of young women patrons increases, so does the number of men patrons. In order to sell more liquor and beer, the bar could develop a strategy to get more men in by targeting women. In order to do this, the bar could take advantage of different group compositions. By making assumptions about how many men will show up (and how much an average male drinks) based on the number of women present, the bar could offer higher-value free products to larger groups of women and lower-value, but still free, products to smaller groups of women. For example, a group of five women might be given a free mixed drink for each person while a group of three women might be given a free platter of tapas. As men may be expected to be more attracted to younger women patrons, if the promotional offers are targeted to all women groups whose average age is 22-27, regardless of the size of the group, the promotional offer would be expected to be most effective. Thus, by being able to create promotional offers using defined group compositions, and being able to target groups specifically with these compositions, the bar could utilize group compositions to strategically optimize client mix and profitability. Similar analyses are equally applicable to other businesses that cater to ad hoc groups.

Consumers increasingly use computers and mobile devices to inquire about what businesses may be in a given location, and to make choices about where to go and what to do. Such inquiries may also be facilitated by an automobile's onboard computer. Historically, advertisers of service-oriented businesses have had several options to reach consumers via these devices. In many cases, a consumer will utilize a search engine to view the options in a particular service category in a particular area. The search engine will utilize location, demographic, and behavioral data related to the particular device or individual conducting the search. The search engine will have stored numerous promotional offers related to that category. The promotional offers are displayed on the basis of two criteria: First is the amount the advertiser paid to show the advertiser's promotional offer most prominently relative to other promotional offers in that category; second is the promotional offer's relevance to the user doing the search. Relevance is determined by location, the data available regarding the individual user, and the search engine's ad-matching system. Thus, even though a group of related individuals may visit a service-oriented business as a unit, a service-oriented business using this targeting strategy will essentially pay to have one member of the group directed to its website. In this case, the business is blind to the number of individuals (and the demographic mix) who will potentially visit the business as a unit and, under present marketing strategies, cannot create suitable promotional offers to capitalize on the group's composition that can optimize business profitability and be attractive to this group.

Another known strategy is to target promotional offers based on the characteristics of individual users of numerous services such as Foursquare, Groupon, or Facebook. In each of these situations, it is the demographic, location, preferences, and behavior of individuals, or various combinations of those parameters, that is utilized to target them. These and other advertising systems may group individuals together based on common characteristics in order to simplify the targeting of them. However, the structure of the promotional offers is largely intended for individual consumption. For example, an advertiser can target promotional offers for a specific age and gender group (e.g., 25-30 year old men) (demographic targeting), who attended a specific concert (e.g., The Grateful Dead) at a specific venue (e.g., American Airlines Arena) in a specific city (e.g., Miami)(location and event targeting), who have shown a preference for a particular genre of music (e.g. rock music)(preference targeting), or persons who bought a particular item (e.g., a sweater) via a group discount from a specified retailer (e.g., Target) (purchasing habit targeting), and are near a specific restaurant (e.g., Gino's Pizza) at a given location (e.g., on Broad Street) (location targeting). The advertiser can group all the individuals with these characteristics together and target promotional offers to this artificial group. However, the advertiser will still be targeting individuals with these common characteristics, and will not be creating and targeting promotional offers that all of the members of the group will want to take advantage of as a unit. Thus, in the case of service-oriented products, there is a mismatch between the unit for which a promotional offer is created and targeted (the individual), and the unit (group) that will likely visit the advertiser's place of business as a unit. Such a situation limits an advertiser's ability to craft promotional offers based on specific group compositions.

The gap exists also with promotional offers such as “bring [x] friends and get the [xxx] deal”. Such promotional offers are seen on Foursquare, but are targeted at individuals, requiring the individual to gather the necessary friends in order to take advantage of the offer. Presently, there is no advertising system that specifically targets groups of “x” size with promotional offers meant for groups of “x” size to consume together as a unit. Moreover, other than the individual that the promotional offer is targeted towards, the advertiser cannot specify the demographic composition of the other group members which is needed in order to take advantage of the promotional offer. This too limits the types of strategies an advertiser can employ to influence customer mix and business profitability.

In addition, in the past a group of unrelated individuals may have been targeted with a promotional offer that requires them to combine their purchasing power in order to take advantage of a lower price point. These promotions can be seen on Groupon. Although the advertiser is targeting a group of individuals and may require a specific number of units to be sold in order for the group to take advantage of the discounted price, the product or service being advertised is not going to be purchased and consumed by the group unit that is being targeted as a group. If it is a product promotion such as an iPad for sale, individuals will separately purchase it online and have it sent to them separately via mail. If it is a service such as 50% off a massage, individuals will separately purchase it online and redeem the promotion separately. The entire group of individuals targeted with the promotional offer will not go in to the advertiser's business as a unit to redeem the promotion. Thus, it is the individual that will ultimately purchase and consume the product or service regardless whether the individual is combining his or her purchasing power with others to get a lower price. This strategy does not take advantage of group units coming to a service oriented business as a unit and does not take advantage of the potential demographic mix a group unit will bring. It is only one strategy (higher unit sales in exchange for lower per-unit revenue) an advertiser can pursue.

The prior art also discloses a promotional system in the form of a mobile application whereby one or more mobile device users are able to notify friends that they are gathering at a local business's location, and any friends who join the gathering will receive a promotion from the business. In this case, the business's promotional offer is universally targeted at everyone in the geographic vicinity, and there is no group-specific or demographic targeting. When creating the promotional offer, the business does not know the size of a group that may take advantage of the promotional offer nor what the demographic mix of the group will be. The promotional offer is made blindly to any group that chooses to advantage of it. Thus, an advertiser is limited in being able to craft promotional offers that will have defined profit expectations as the advertiser has no idea of how many individuals (and their demographic mix) will attempt to take advantage of it.

Another instance of the present use of the mobile application is that a second business can advertise a service promotion to a group of individuals who have already gathered at some other location. In this example, the second business wants to attract the party to its own location. The second business may have information sufficient to estimate how large the group may be, based on number of RSVPs or even the number of people currently at the gathering. However, the second business will not know in advance how many individuals will take advantage of a second promotional offer, and cannot specify a minimum group size that will be required in order to receive the promotion. Thus, an advertiser (the second business) cannot create a promotional offer with a defined expectation of how many individuals will take advantage of it, and therefore is limited in what it can do. Moreover, the advertiser does not know the demographic mix of the individuals that may show up and therefore cannot tailor its promotional offers to any demographic mix. Finally, the advertiser is largely reacting to the potential estimate of the group size that may take advantage of a promotional offer, but does not have time to create a suitable promotional offer based on an estimate of group size as the mobile application is meant for parties that take place within a 24-hour time horizon.

### SUMMARY OF THE INVENTION

What is needed is a system that signs up short-term group units who are able to take advantage of a promotional offer as a unit, and to track usage so that relevant entities may receive compensation in accordance with predetermined arrangements. Such a system can match the unit that will ultimately take advantage of a service promotion with a promotional offer that was created and targeted with that unit specifically in mind.

The conception and development of internet-based advertising has gone through a number of iterations from its early beginnings to reach a point at which advertising content, web page publishers, advertisers, and advertising facilitators are coordinated into interactive systems that provide unsolicited advertising content directly to users. These systems target users who are accessing a page on a participating web site to provide relevant on-line advertising when the page is opened. Such systems and methods are well-known in the art, and are continually developing to integrate new methods and technologies to bring advertising to users, and to provide appropriate compensation to participants in the system. The on-line advertising industry consists of a number of servers, each providing one or more components of the system, to deliver advertising services. Typically, an ad tag will be embedded in a publisher's web page that is loaded into a user's browser when the user accesses the page. When the page is loaded, the ad tag makes a call for advertising content. The request may be delivered to an adserver belonging to the publisher of the web page, or may be delivered to an adserver, network, exchange or other entity that handles advertising inventory on behalf of the publisher. In many cases, multiple servers will be involved in presenting an advertisement to a user. For example, an adserver may decide which advertiser's material should be shown; the advertiser's server may decide which deliverable content (called a “creative”) should be shown; and a content delivery network (CDN) that actually hosts the creative image file will deliver the creative to the user's browser—and all may be different servers. These coordinated servers and services will be collectively described herein as an advertising exchange, or “ad-exchange.” For purposes of the invention, an ad-exchange may receive requests for the delivery of promotional information, and may also be provided with a Group Definition Code (“GD Code”) that provides information about a group such that a relevant promotional offer may be delivered in response to the request. The GD Code may be proprietary and, if so, a proprietary decoding module will be provided to relevant ad-exchange servers so that relevant promotional offers may be selected and offered.

The invention is not dependent upon any particular system or method of providing advertising, but is a method of creating groups and soliciting promotional offers that interfaces with the generic ad-exchange server. The system of the invention places a request for a suitable promotional offer and provides information that may be used to select a promotional offer that is relevant in terms of time, place, and group demography. In response to the request for a promotional offer, the ad-exchange will deliver a relevant promotional offer, if one is available. Depending upon the specific promotional offer, and the terms of agreement with the ad-exchange, further processing may be handled through the proprietary server of the invention, or may be handled through the ad-exchange, or a combination of both.

Use of the invention commences through a sign up process, during which the group size and demographic composition (sex and age) of the group members may be determined, giving the group a definition. By defining the size and demographic mix of the group, advertisers are given the ability to create promotional offers that utilize a variety of strategies to take advantage of specific group compositions. Advertisers are thereby provided with greater flexibility in creating group-based promotions than is possible with current systems. Moreover, because these groups are signed onto the system, they can be targeted by promotional offers that are created specifically with their compositions in mind. Thus, the invention provides a better matching mechanism then exists in current systems.

In addition, the system can create the group composition sought by a particular promotional offer by matching two or more previously unrelated groups and providing an opportunity for them to meet up to take advantage of the promotional offer. Thus, the system can actually create the group composition from two or more groups that a promotional offer is targeted to reach, which is another improvement over current systems. The system also includes a promotion redeeming step that ensures that the specific group composition the advertiser has targeted for a promotional offer is the composition of the group that actually shows up to take advantage of it. These features ensure that the specificity provided by the system exists from promotional offer creation, to targeting, and finally to redemption. Finally, this system tracks the behavior of groups based their composition. By tracking and storing information on, for example, groups of five men age range 25-35 or mixed (male and female) groups of four in an age range 35-40, the system can better help advertisers understand what groups are in their vicinity most often or during different times of day and what types of promotional offers such groups will be more inclined to participate in. Such market intelligence can be generated on a weekly basis in report form for advertisers using this system. Furthermore, in some cases the system may track and store information on groups who will be in a particular location at a timeframe in the future. Such market intelligence enables advertisers to determine or estimate ahead of time how many groups registered in the system are going to be in the advertiser's vicinity (the system can generate reports on this as well). This would allow advertisers to craft promotional offers with specific groups in mind. Finally, by tracking and storing information identifying the types of promotional offers differently composed groups respond to, the system can analyze such data to suggest an order of preference of promotional offers that a particular group is most likely to adopt. This order of preference could then be used as a factor in presenting multiple promotional offers to user groups, thereby making viewing the promotions easier.

There are a number of situations in which different embodiments of the invention may be applied. Among the exemplary embodiments and environments for forming groups are using third-party mobile service providers; forming mobile groups with via texting and social networking sites; using mobile devices with intergroup awareness and communications; using centralized group registration and promotion systems; using third-party websites; and creating groups through an ad network for automobiles.

It is an object of this invention to provide methods of delivering promotional materials and coupons to groups of related individuals who may take advantage of the coupon as a group.

It is another object of the invention to provide advertisers a method of soliciting groups of individuals who may redeem a coupon only as a group.

It is a further object of the invention to provide advertisers with a method of targeting groups satisfying a demographic parameter whereby promotions can be directed at individuals having a specific demographic trait.

It is yet another object of the invention to solicit user groups through third party websites whereby revenues may be shared between the system operator and third party website operators.

It is another object of the invention to provide a method of forming a larger group from previously unrelated smaller groups for the purpose of redeeming a promotional coupon that is specific only to the larger group.

Yet another object of the invention is to solicit user groups through third-party mobile service providers and automobile rental companies.

These and other objects of the invention will become apparent through the following detailed description of the invention.

### BRIEF DESCRIPTION OF THE DRAWINGS

FIG. 1 is a diagrammatical overview of major components the invention and their interconnections.

FIG. 2 is a flowchart of an embodiment of the invention.

FIG. 3 depicts major components of an embodiment in which the user's device uses cellular communications.

FIG. 4 is a flowchart of another embodiment of the invention.

FIG. 5 depicts an embodiment of the process of creating a group.

FIG. 6 depicts an embodiment in which a social network is used to assist in creating a group.

FIG. 7 is a flowchart showing an embodiment in which a third party's website offers promotional materials.

FIG. 8 depicts another embodiment in which a third party website initiates the selection and delivery of a promotional offer.

FIG. 9 depicts another embodiment of the invention.

### DETAILED DESCRIPTION OF THE PREFERRED EMBODIMENTS

FIG. 1 provides an overview of the system of this invention and its interaction with the ad-exchange industry. Individual embodiments may vary from this overview, which is presented only as a general model for conceptual understanding. Advertisements and promotions are maintained within a generic ad-exchange system 10 in which advertisers, web page publishers, and others may be participants. Each targeted promotional offer may be classified according to various parameters, which may include group size, gender mix, age range, geographic locale, time period for targeting, redemption, or use, and any other parameters a merchant may deem relevant. The invention encompasses methods for forming groups who may then solicit and accept promotions and other marketing devices.

In FIG. 1, a proprietary Group server 24 is in communication with user groups I and II, 20 and 32 respectively, across the internet or other wireless technology, such as cellular. An individual having a mobile communications device 18 is a member of one of the groups. The Group server 24 may be in communications with one or more social networks 28 and may also maintain its own database for holding information regarding groups, individual group members, and other relevant or historical data. Merchants and advertisers 22 who wish to take advantage of the system's facility to target advertising toward various demographic groups, and who will redeem promotional offers, may also be in communication with the Group server 24. Selection and provision of promotional offers will generally be handled by an ad-exchange 10. Groups may be defined by a group definition code, or GD Code, which may be provided to the ad-exchange system for purposes of selecting relevant promotional offers.

FIG. 2 generally depicts the steps from obtaining to redeeming a promotional offer. Referring to FIGS. 1 and 2 together, an individual 18 wishes to form a first group 20 to solicit and use a promotional offer. There are a number of ways in which this can be done, depending upon circumstances. For example, if user 18 has already determined the membership of a group to be formed, he or she need only enter information related to the group and its anticipated activities into the internet-accessible device 40. In some embodiments, software such as an application on a mobile device or computer 18 may analyze the data and produce a group definition code (“GD Code”) 14 that, when decoded, provides information sufficient for an ad-exchange system 10 to respond with a promotional offer. In other embodiments 42, the software necessary to generate a GD Code may be resident on a Group server 24, where it will accept information 26, 44 provided by the user's device 18 and return a proprietary code 14.

In general, the user can utilize either of two input protocols made available by the application software. The first protocol requires the user to input data that may include the group's numeric and demographic information only. In this case, the user's location would be determined by the software. This information may be translated by the application into a GD Code that may represent the group's description and location 46. In the second input protocol, the user may input the group's numeric and demographic information along with an intended destination and expected timeframe to arrive at the intended destination. In this case, the information is translated by the application into a GD Code that may represent the group's numeric and demographic information, as well as intended destination and expected arrival time at the intended destination. In either input protocol, the device utilizes the generated GD Code as part of a request 48, 52 for a promotional offer that is transmitted to the ad-exchange. The request under both input protocols includes a request for a promotional offer to be delivered back to the device, either through the Group server 58 or directly to the user's device 56. The process of entering user demographic information, as well as establishing the user's location, and retrieving related promotions may be repeated if the user should change the group composition information, change location, or update the location the group is expected to be (and expected timeframe), thereby changing different aspects of the proprietary code created by the integrated software. With the updates, the software could create and send newly formed ad requests to the ad-exchange server.

In situations in which the user 18 wishes to use the Group server 24 to assist in creating a group 42, the user may request information 26 from the server 24 regarding others who wish to form a group. Alternatively, user 18 may directly access one or more social networks 28 to retrieve available information 30 regarding other potential group members. Depending upon user 18's level of access, he or she may be able to locate other potential group members in the same vicinity, or whose interests are similar, or who have otherwise expressed an interest in taking advantage of promotional offers. In another alternative, Group server 24 may simultaneously be in contact 34 with a social network 28 or with a second group 32 who are also seeking to solicit a promotional offer. Group server 24 may notify the first 26 and second 34 groups 20, 32 who may then conduct direct communications 36 to coordinate and solicit a promotional offer.

The described methods of forming a group are not exclusive, as other embodiments may also result in group formation. When a group is formed, a user 18 may then request a promotional offer from the ad-exchange system 10.

In an embodiment, the Group server accepts the request for a GD Code. If the request includes only the demographic information related to the group and the group's location, the Group server may determine the time of day for which the request is relevant. If the request also includes an expected timeframe for arrival at an intended destination, the Group server will incorporate this information into the GD Code to be sent to the ad-exchange system. Software built into applications to be run by a mobile device to create a GD Code may include similar functionality.

Once a group has been created, and a GD Code has been requested 44 and created 46, a request 12 for a promotional offer together with a GD Code 14 may be sent to the ad-exchange system 10 from the user's device 18 or from the proprietary server 24. In either case, the ad-exchange system will receive the GD Code, from which information regarding the group may be extracted and used to select relevant promotions. The code 14 may be proprietary, or may be publicly disseminated for wider use and incorporation in ad-exchange systems. Group information that may be extractable from the code 14 may include such information as the sex and age of each group member, relationships between group members (i.e., spouses, family, casual friends, etc.), locale for which a promotion is being sought, type of promotion (e.g., movie, restaurant, bar or night club, other amusement, etc.), and time for presentation and redemption.

The ad-exchange system will select a promotion and present it 16 to the requesting device 18 which is associated with the group 20. The promotion may include terms that must be adhered to for its successful redemption. For example, in some cases, a promotion may be accepted simply by the group's going 40 to the place of redemption 22 and participating in specified activities. In another case, the group may be required to make an advance purchase or reservation before going to the place of redemption. In some embodiments 64, a soft copy of the offer may be provided to the user to be printed or preserved as an image on a mobile device. In other embodiments 64, a purchase may be required, either as advance payment for an item that is the subject of the offer, or as a precondition to receiving the offer.

The promotional offer may be presented for redemption at a merchant's business 66. If the conditions have been met, the ad may be redeemed and notification may be provided to the ad-exchange 68 or the Group server 70, or both, so that compensation may be determined and provided to the correct participating entities 72, 74.

When the promotion is redeemed, the redeeming merchant 22 (or its designated agent) may verify that the required terms of the offer have been satisfied, and may convey that information 38 to a group server 24. The group server 24 will record the event in a proprietary database, and may provide accounting services to designate how payment for the promotion will be distributed. In addition, the group server 24 may provide information to the ad-exchange system to be used in further accounting and monetary distribution, in accordance with preexisting contracts.

In some embodiments, the ad-exchange server 10 may be programmed to assess a request for a promotional offer and, upon certain conditions having been met, to redirect the user's mobile device to an ad server maintained by a merchant offering a relevant promotion. This embodiment may permit the merchant to modify the promotion on its own server at any time before it is delivered to a mobile device. In this case, the merchant may be provided with a module for deciphering a proprietary code so that a user's request may be matched with a merchant's promotional offer. In another embodiment, a merchant receiving such a request for a promotional offer may respond to its own immediate business conditions by generating an offer “on the fly” to be delivered to a user's mobile device.

Upon selecting a promotion for viewing, the user may be presented with a softcopy of the promotion, including information sufficient to make an informed choice about whether to accept the promotion. In an embodiment, the user, acting on behalf of a group, may accept the promotion simply by making a reservation on-line with the advertising merchant by reserving a place for the number of people in the group, providing a time, and identifying the promotion. In another embodiment, the user may use the mobile device to call the offering merchant and make a reservation. In either case, information may be returned to the system ad server indicating that action was initiated on the promotion, and recording information sufficient to permit distribution of revenue amongst the participating entities. In the event that a promotion must be “purchased” before being redeemed, information necessary to complete the purchase may be provided in the same manner as described for a user's acceptance of the promotion.

Mobile Device Cellular Communications

In another aspect of the invention, many mobile devices generally have at least two methods of communicating. Some mobile devices have wireless access to a node connected to the Internet, and may directly communicate with remote sites over the Internet. In addition, some mobile devices also communicate using cellular technology, in which data may be downloaded through a cellular provider who has offered a subscription service.

In an embodiment, a third-party mobile service may adopt and use the ad promotion system via cellular communications with mobile devices. Software from the system may be integrated into the mobile device's application. This embodiment allows multiple users within a single group to use the system. In addition, this embodiment may access a social network's web server or the cellular service provider's database of user data to create the group, collect the demographic data, and gather or compile the group members' pictures and initials. The collection of this data via a social network makes capturing the data and pictures easier, as these items are readily available from social networks. Pictures are an element for the “group-on-group” interaction aspect of this system.

Once the group is formed, the group information may be sent to the users' mobile devices by the cellular service provider. With this data, the integrated, device-native software may create a GD Code to be included in an ad request sent from the mobile devices to the ad-exchange via the cellular service provider. The ad requests would also include each user's location information. After receiving the ad requests, the ad-exchange would search for matching promotions, determine which promotions to send, and send the promotions to the users' mobile devices.

FIG. 3 depicts an embodiment in which a third-party cellular service provider 80 may integrate a proprietary GD Code generating software module into their device's software. When cellular communications to the cellular service provider 80 request a promotional offer, the cellular provider will forward the request to an ad-exchange server 10 via the Internet along with a GD Code, and will return the requested promotional to the requesting device. In some embodiments, the group numeric and demographic data may be entered into the mobile device and sent by cellular communications to the cellular service provider 80 who will translate it into a GD Code, or will have the Group server 24 generate the code. The GD Code, along with the group's location, may be included as part of an ad request sent to the Group server or the ad-exchange server from the cellular provider. The system ad-exchange server may search for matching promotions, determine which promotions to send, and send the promotions to the cellular provider 80, which will then send them to the user group's mobile device 18 via the cellular network. Regardless whether the mobile device is communicating wirelessly directly to the Internet or is communicating with its cellular service provider, the mobile device user will provide the same group-defining information and will receive the same promotional offer(s).

If a promotion is sent to a group, the user group may “click” on a short description of the promotion in order to view a more detailed description of what the promotion entails. Where this is done, a “cost-per-click” model may be implemented in which the ad-exchange pays the participating entities that may include the third party service provider in accordance with preexisting contractual arrangements.

In some embodiments, upon receiving an offer, a user group may call an advertiser's business to make a reservation for the group to take advantage of a promotion. This may be done by “clicking” on an area of the promotion. In this case, a “cost-per-action” model may be implemented by the ad-exchange server. As a non-limiting example, an advertiser may pay the promotion system operator and third-party mobile service provider each time a user calls the advertiser's business.

In a related embodiment, the promotion system may be adopted by one or multiple rental car companies. Software may be integrated into onboard computers of card in a rental fleet which may allow user groups to input their numeric and demographic data. The onboard computer may establish the time of day and the location of the automobile the user group is driving. This information may be translated into a GD Code by the integrated software. The GD Code would be included in an ad request that is sent from the automobile's onboard computer to the ad-exchange via a cellular network if no wireless internet connection is available. The ad-exchange may receive the information from the ad request and select promotion offers using, but not limited to, the group's numeric and demographic data, as well as the group's location and time of day. Matching promotions are delivered to the onboard computer and viewed by the group using the computer's user interface. Thus, the system may be used as an ad serving platform of available promotions to user groups renting automobiles from one or more rental car companies.

Aggregation of Groups

In an embodiment, promotional offers may be so large that a single group does not have enough members to be able to accept the offer. In another embodiment, a merchant may choose to facilitate group connections by offering promotions that two or more groups can redeem only if they met up to do so. Such promotions could be offered to two (or more) groups that are already communicating. In either case, two or more groups may combine so that the aggregation of the groups enables them to accept a promotional offer. In this embodiment, users have the ability to allow groups to view other groups nearby, for each group to see pictures of the members of other groups (together with their initials), and for inter-group communications to occur. The method allows two user groups to be signed up by two individuals via their respective social network accounts. The process involves accessing these individuals' social network accounts via the social network's web server, and using a device-native software application.

In this embodiment, a single promotion is matched to two groups who are communicating. Communication may be facilitated by the Group server via the assignment of a specific phone number to connect the two groups. When communication occurs between two groups, the Group server may combine the numeric and demographic data of the two groups and translate this data into a GD Code. This code is part of an ad request that is created by the Group server and sent to the mobile devices of the two groups. With, but not limited to, this information, the devices create ad requests that are sent to the ad-exchange server. The ad-exchange selects promotions on the basis of the combined group's composition, amongst other possible selection criteria, and sends the selected promotion back to the user groups' mobile devices.

Redemption

FIG. 4 illustrates two paths for redemption of a promotional offer. In an embodiment primarily suited for establishments in which computerized reservations and on-line communications are not available, a phone reservation 90 is the primary means for notifying an advertising merchant that a promotion is being accepted. When the group arrives at the merchant's establishment, the merchant would determine whether its terms have been met 92. At that point, the promotion may be accepted or not, depending upon whether or not the group composition satisfies the promotion's requirements. If the group satisfies the promotional requirements, or if the merchant waives the requirements, the promotion is accepted and redeemed 94. Otherwise, it is not redeemed and will expire 96. In this embodiment, a “cost-per-action” model would require payment by the merchant for the advertising service based upon the user group's ‘action’ in calling the merchant and making a reservation. Revenue from the advertising merchant may be split between the operator of the system ad server and the third-party system from whom the user group originated.

In another embodiment in which the redemption process may be automated, the promotion may take the form of a softcopy voucher 98 that has been delivered to the user's device and is presented to the advertising merchant at the time it is being used. If the merchant finds that the conditions for redemption are not met 100, the voucher will not be redeemed 102. If the conditions for redemption are met 104, the softcopy voucher may be scanned 106, and information confirming redemption will automatically be delivered to the Group server 108 or ad-exchange and recorded for accounting and payment. If a scanner is not present 104, the voucher may be manually recorded 110, entered into the merchant's computer 112 accessing the system web server 46. Once the voucher information is acquired by the system web server, it is saved in the system transaction database 48 for recording and eventual payment.

FIG. 5 depicts an embodiment of a system in which a group initiator 18 creates a group on a Group server 24 accessing data on group members from either a social network web server 28 or the Group server's own database of user information. The Group server 24 accesses data from a social network 28 or its own database such that a list of potential group members can be formed 120. Once the group list is formed, in an exchange between the social network 28 and the Group server 24 (or the Group server's own database), the group's numeric and demographic information, and group members' pictures and initials may be transmitted to the Group server, thereby forming a group list that includes the group members identities and information. The group list may include the group's numeric and demographic information, as well as group members' pictures and initials, is sent from the Group server 24 to the users' devices 122. Utilizing a device-native, proprietary software application, the users' devices intake the transmitted data on the group. The application then establishes the location of each user. With the group information and each user's location, the software translates this data into a GD Code 14. The GD Code 14 may include data on the group's numeric and demographic information, as well as the location of each user and could be different per user depending upon how close in geographic vicinity each user is to one another. The GD Code generated by each device 122 is part of an ad request sent from each device 122 to the ad-exchange 10. The ad-exchange 10 receives the multiple ad requests. It then determines the time of day for each device that is making the separate ad requests and selects promotions on the basis of the group's numeric and demographic makeup, the time of day and the location of the user. If suitable promotions are available, the system ad server sends one or multiple promotions to the users' devices 68.

Another embodiment of the invention is shown in FIG. 6, in which two separate groups are independently formed and arrange to meet one another for purposes of accepting a promotion. Users 1 and 2 create Groups I and II, 20 and 32 respectively, utilizing the Group server 24 to access group members' information on a social network 28. Groups I and II make themselves known to each other by accessing group information on the Group server 24 which will communicate with each group and provide information about the other. If the groups decide to communicate and meet, they may exchange information in the form of device-to-device communications such as e-mail, texting, or telephone via a cellular network 130 or the internet. The Group server may establish an inter-group account to facilitate communications, and may also pull numeric and demographic data and location data from the two groups to create a GD Code 14. In some embodiments, the GD Code may be embedded within an ad tag (that can be HTML or JavaScript code) that is delivered to the groups via a web page. The GD Code may include the combined numeric and demographic composition of the two communicating groups and would be sent to each group's mobile device. Each group's mobile device will then communicate with an ad-exchange 10. The ad-exchange will select promotional offers matching the ad tag's proprietary code. The promotional offer may be offered conditionally, such that the groups must be combined in order to accept the offer. If the offer is accepted 132, the groups may be directed to the advertiser's reservation server 134, or to the advertiser's telephone number where a reservation can be made. If the offer is not accepted 136, it will expire.

Specialized Websites

FIG. 7 depicts an embodiment in which a third-party web site 140, which may be operated, e.g., by a travel company, allows users to choose from a variety of services, one of which may be to allow a user to solicit group promotions. Upon receiving a user's request to access group promotions, the user representing the group 20 may be redirected to a page that may be published by a proprietary Group server 24 or that may be sponsored by the travel company or other third parties, where information regarding the group's composition will be requested. In a preferred embodiment, such information may be quickly provided through the use of a display having radio buttons, check boxes, local maps, and the like, such that the user need only click on specific predetermined choices. The Group server will format the information into fields or classifications similar to those used for targeted promotional offers. That is, the group will be classified according to group size, gender mix, age range, destination or geographic local, and relevant timeframe. This information, along with an e-mail address the user has provided during the group signup process, may be saved as a group account in the Group server. In an embodiment, information may also be maintained regarding the identity of the user accessing the system, including the user's express or implied preferences for entertainment, group demographics (i.e., a family of two adults and two children of ages 7 and 10), locale, and the like in a database 142 maintained by the Group server 24. Upon formatting the user's information, the Group server may then access the ad-exchange system 10 and request a promotional offer to be presented to the user.

A suggested match or matches may be presented to the user in a number of ways. In a preferred embodiment, a coupon may be sent by e-mail by a system e-mail server 148 to the e-mail address provided by the user or attached to the user's account or record maintained by the system user group database. In one e-mail format, a promotional offer may be presented in the form of an attached coupon which is a soft copy of the offer. If the user intends to accept the offer (100 in FIG. 4), he or she may print the coupon to create a hard copy. The user, along with the other members of the group, may present the coupon to a merchant at the place where the offer is to be redeemed. Upon the merchant's verification that the terms of the offer are satisfied (104 in FIG. 4), i.e., that the group is the appropriate size, age range, and gender mix, the coupon may be collected and an embedded barcode scanned, at which point the user's group will receive the promotion 154.

In the event that no match is found 144 between the user or user's group and the currently-offered promotions, the user's group 20 will be so notified 146. Until the destination arrival timeframe specified by the user during the group signup process expires, the Group server 24 may periodically query the ad-exchange 10 to find promotions that match the user group's information. If a match occurs after a period of time following the group's initial registration, the Group server could offer the matched promotion via e-mail or web link 148. If a match is found 144 but the users' group does not accept the promotion 150, the promotion will expire 152. If the promotion is accepted 150, it may be redeemed 154, and information will be reported back to the Group server 24 or ad-exchange 10 or both.

Information from the merchant's barcode scanner may be delivered back to the Group server 24 which will indicate that a promotion was redeemed, identify the promotion that was redeemed and the advertiser's location, the demographic information of the group that redeemed the promotion, the date and time of redemption, and where applicable, will identify the ad-exchange server 10 from which the offer was made. The transmitted information may also be saved in a user preference database 142. This information may be used to assess the effectiveness of certain promotions to specific groups within an identified region for particular goods or services and to track trends to assist in creating future group marketing promotions for merchants. It may also be used to rank multiple promotions matched to a particular group on the probability that the group will take advantage of them. This can be used to create an order in which multiple promotions matched to a single group are displayed to that group in the e-mail sent to them. The saved information will also determine payments that may be due to a third party website for initially attracting the user.

In addition, the Group server 24 that received information regarding redemption of the promotion may transmit the information to the ad-exchange 10 and into a user preference database 142 to assist in suggesting other promotions or preferences the user may have in the future.

In an alternative embodiment, the ad-exchange system 10 can send a resulting match to the user in the form of an e-mail 148 having an embedded link back to a site on the Internet. In this case, the user can simply click on the link and be taken to a web page upon which the promotional offer is displayed. If the offer requires the payment of money, e.g., two tickets for admission to the cinema, payment can be made on-line through any commonly known payment method and a hardcopy coupon or ticket may be printed. Alternatively, the user may simply be presented with a coupon image that may be redeemed by the group upon presentation of the image on the user's mobile device to the offering merchant.

In all of these cases, information regarding the group may be tracked and marketing data can be obtained whenever an offer, coupon, or voucher is redeemed and the server receives information related to the redemption.

FIG. 8 comprises an embodiment in which an ad-exchange network 10 works directly with user groups and with websites (publishers) 160 and advertisers (merchants) 162 to provide promotional offers. In this embodiment, the entering of user-group information into the promotion system may occur at third-party companies' websites, such as, for example, travel companies' websites, without being redirected to a Group server. The websites may implement and utilize proprietary software to capture and translate user groups' information into part of an ad tag. The ad tag would be sent from the third-party website to the user's browser. The ad tag would instruct the user's browser to send an ad request to the ad-exchange. Users may access the promotion system via certain relevant websites 160. Third party travel companies' websites are one example of such relevant sites. Publishers for these websites may include ad tags 22 soliciting advertisements to be presented in a section featuring promotions tailored for specific groups, or alternatively, may be on destination specific web pages that appear when a user is planning a trip to one of those destinations. In addition, such websites may also include a “button” to be clicked or selected, whereupon a visitor to the site may be choose to receive a promotional offer. Upon selecting this option, the user may be redirected to the promotion system and would no longer interact with the original website.

Using web browser software, a user (or a user group) 20 may visit a publisher's website 160 on which is displayed a “button” for “Promotions Specific to Your Group”. The user clicks the button and the publisher's server launches a group definition software module 166 (which could be a web application or programming code that allows the user to enter the group's information via radial buttons) that accepts the demographic and numeric data regarding the group, and the planned location and timeframe. The software module translates the user data into a GD Code, integrates it into an ad tag 168, and delivers it to the user's browser 20. The browser receives the information in the ad tag and may add additional information to it to form an ad request sent from the browser to the ad-exchange server 10.

The ad-exchange system 10 will identify group-composition-specific promotional offers that are maintained in a database holding promotional content 164. Advertisers (merchants) 162 will specify the group composition their promotions will target, and the location and times in which their promotions will be offered to user groups and may be redeemed by them. The ad-exchange server matches the ad request to promotional offers 144 primarily utilizing group composition, location, and anticipated arrival times, although other matching criteria may also be used. If the group is matched with promotions 148, the matching promotions are sent to the user's browser where they are viewed. If there are no current promotions that match the group's criteria 146, the ad-exchange server notifies the user.

In this embodiment, the promotion system performs the functions of a Group server, and processes ad requests and promotional offers as described with reference to a Group server. As such, the entry of group composition, destination, and proposed arrival time at the destination would be captured only by the promotion system. In this embodiment, the system may function as a centralized collector and depository of group accounts. The system may also serve as a centralized promotion depository for promotions from numerous advertisers. Promotions from this centralized database of promotions may be matched to group accounts in the centralized depository of group accounts which may then be sent via email to the users.

In one embodiment, the promotional offers delivered to the user's browser may be expanded into a coupon that is a softcopy of the promotion. The softcopy may be printed as a hardcopy and taken to the Advertiser's business. In this case, acceptance and redemption of the promotion may be handled as previously described with reference to FIG. 4.

In an alternative embodiment shown in FIG. 9, once an offer has been matched to a GD Code 14, a redirection “click tag” 168 may be embedded in a promotional offer sent to a user's browser 20. The action of “clicking” on the promotion may redirect the user's browser to the Advertiser's website 162, where further Advertiser-selected information may be displayed. In this case, where a merchant is advertising on website controlled by the merchant, promotional offers may be modified by the merchant in accordance with conditions immediately present in the merchant's place of business. For example, if the merchant is a restaurant, and business should be unexpectedly slow on a given evening, the merchant may modify the promotional offer to make it more economically advantageous and thereby seek to attract more patrons to the establishment. Alternatively, if business should be unexpectedly strong on a given evening, the merchant may wish to refrain from extending some promotional offers, and thereby avoid having patrons who accepted promotional offers experience a long waiting time before being seated. The action of clicking on the promotion may also notify the ad-exchange server 160 that the promotion was clicked on. In this case, the ad-exchange server may record each “click” into an accounting record that enables the system to charge Advertisers for the number of times their promotions that have been “clicked” on, in accordance with existing contractual arrangements.

I claim:

1. A method of providing a promotional offer to a group comprising the steps of:
providing a group server, said group server being in communication with at least one individual via the Internet or cellular communications, and being in communication with an advertising exchange (ad-exchange) via a server comprising said ad-exchange and being connected to the Internet;
providing a classification system whereby promotional offers for groups may be classified in accordance with a number of parameters, said parameters including at least a number of individuals in said group, the age of each individual in said group, the gender of each individual in said group, the geographic location where the promotional offer is to be redeemed, and the time that the group members will be at said geographic location, said classification system being encodable as a group definition code (“GID”);
creating a group of which said individual is a member;
creating a GID defining said group;
providing one or more merchants operating businesses, each said merchant creating at least one promotional offer, said at least one promotional offer specifying conditions regarding a group and being redeemable by a group satisfying said conditions, said at least one promotional offer being maintained on a server comprising said ad-exchange;
presenting said GID to said ad-exchange;
said ad-exchange matching a promotional offer to said GID;
delivering said promotional offer to one or more members of said group.

2. The method of providing a promotional offer to a group as claimed in claim 1, further comprising the steps of:
said group presenting said promotional offer for redemption;
said redemption of said promotional offer being reported to said group server and to said ad-exchange.

3. The method of providing a promotional offer to a group as claimed in claim 2, wherein one or more individuals comprising said group provides said information regarding said group to said group server from a mobile device.

4. The method of providing a promotional offer to a group as claimed in claim 2, wherein one or more individuals comprising said group provides said information regarding said group to said group server from a computer connected to the Internet.

5. The method of providing a promotional offer to a group as claimed in claim 1, further comprising creating said GID on said group server.

6. The method of providing a promotional offer to a group as claimed in claim 3, further comprising creating said GID on said mobile device.

7. The method of providing a promotional offer to a group as claimed in claim 4, further comprising creating said GID on said computer.

8. The method of providing a promotional offer to a group as claimed in claim 3, further comprising the steps of:
said promotional offer being delivered to said mobile device as a scannable image;
said promotional offer being redeemed by being presented and scanned at a barcode scanner at said specified location;
said redemption of said promotional offer being electronically reported to said ad exchange.

9. A method of providing a promotional offer to a group comprising the steps of:
providing an advertising exchange (ad-exchange) comprising at least a server connected to the Internet;
providing a classification system whereby promotional offers for groups may be classified in accordance with a number of parameters, said parameters including at least a number of individuals in said group, the age of each individual in said group, the gender of each individual in said group, the geographic location where the promotional offer is to be redeemed, and the time that the group members will be at said geographic location, said classification system being encodable as a group definition code (“GID”);
creating a group of which said individual is a member;
creating a GID defining said group;
providing one or more merchants operating businesses, each said merchant creating at least one promotional offer, said at least one promotional offer specifying conditions regarding a group and being redeemable by a group satisfying said conditions, said at least one promotional offer being maintained on said server comprising said ad-exchange;
presenting said GID to said ad-exchange from a communication device installed in an automobile;
said ad-exchange matching a promotional offer to said GID;
delivering said promotional offer to said communications device installed in said automobile.

10. A method of providing a promotional offer to a group comprising the steps of:
providing an merchant's web page, said web page being connected to the Internet and having detailed information regarding a promotional offer;
providing a classification system whereby promotional offers for groups may be classified in accordance with a number of parameters, said parameters including at least a number of individuals in said group, the age range of said group members, the gender of individuals in said group, the geographic location where the promotional offer is to be redeemed, and the time that the group members will be at said geographic location, said classification system being encodable as a group definition code (“GID”);
creating a group;
providing an ad-exchange, said ad-exchange comprising at least one promotional offer specifying conditions regarding a group and being redeemable by a group satisfying said conditions, said ad-exchange further comprising means for accepting information regarding said group and creating a GID;
at least one member of said group accessing said ad-exchange and providing information regarding said group;
said ad-exchange creating a GID defining said group and delivering at least one promotional offer to said at least one member of said group together with said GID, said at least one promotional offer being selectable to obtain further information by said at least one member of said group clicking on said promotional offer;
said at least one member of said group clicking on said promotional offer and being redirected to said merchant's web page;
said merchant's web page delivering further information regarding said promotional offer whereby said promotional offer can be accepted by said at least one group member.
